(19) United States
(12) Patent Application Publication
(10) Pub. No.: US 2006/0126427 A1
(43) Pub. Date: Jun. 15, 2006

(54) Device for continuous mixing of dough, comprising a mixing tool, centrifuge and lateral evacuation

(75) Inventors: Gerard Fisson, Saint-Hilaire de Loulay (FR); Laurent Jaunet, Saint-Hilaire de Loulay (FR); Guillaume Vannier, Nantes (FR)

Correspondence Address: BAKER BOTTS, LLP, 910 LOUISIANA, HOUSTON, TX, 77002-4995, US

(73) Assignee: VMI

(21) Appl. No.: 11/176,490

(22) Filed: Jul. 7, 2005

(30) Foreign Application Priority Data
Jul. 8, 2004 (FR) 0407657

(51) Int. Cl. A21C 1/02; A21C 1/14

(52) U.S. Cl. 366/76.6; 366/98

(57) ABSTRACT

A device for continuous mixing of ingredients of a dough based on water and flour is provided. The device contains a vessel that defines a mixing space with a circular cross section, in which a mixing tool, containing at least one radial arm is mounted to rotate around an axis, and motorized devices that rotate said tool. The vessel contains at least a solid ingredient feed opening of space; a liquid feed opening of space; and an evacuation opening for the mixed dough. The evacuation opening is provided in the lateral part of the periphery of the mixing space. A process for production of a dough that provides for mixing of the ingredients by means of such a device and an installation for employment of this process is also provided.

### FIELD OF THE INVENTION

The invention concerns a continuous mixing device for ingredients of a dough based on flour and water, a process for producing such a dough, which prescribes for continuous mixing of the ingredients with such a device, as well as an installation for employment of this process.

The mixing device according to the invention is intended, in particular, to grind the dough prior to its kneading. This device is used, in particular, in installations for producing dough based on flour and water continuously, when the mixed dough is continuously kneaded, or kneaded batchwise, when the mixed dough is recovered before being kneaded.

### BACKGROUND

Mixing devices containing a mixing chamber for different ingredients, especially water and flour, and a chamber for continuous evacuation of the mixed dough into a kneading vessel are known. The mixing chamber is provided with a mixing tool operated by a first motorized device. In addition, a continuous evacuation tool extends between the mixing chamber and the evacuation chamber, so as to continuously advance the mixture formed in the mixing chamber to an outlet opening provided on the evaluation chamber. This evacuation tool was operated by a second motorized device, different from the first.

One problem of this type of device is that its structure is complex, because it requires the use of two distinct motorized devices and two distinct tools. In particular, the use of two tools with their motorized devices requires a special and complex arrangement to avoid interactions between the tools and/or the means that ensure transmission of rotational torque between the tool and its motorized device. Moreover, the maintenance procedures, especially cleaning, of the mixing device are not optimal.

Moreover, because of this complex structure, this type of device has substantial weight and space requirements, which poses problems, especially when the device is integrated in a dough production installation.

The invention seeks to solve these problems by providing a structure of the mixing device that permits mixing of the ingredients and evacuation of the mixed dough with a single tool.

### SUMMARY OF THE INVENTION

For this purpose and according to a first aspect, the invention concerns a continuous mixing device for ingredients of a dough based on flour and water, said device containing a vessel the defines a mixing space, having a circular cross section with radius R, in which a mixing tool, containing at least one radial arm, is mounted to rotate around an axis, and a motorized device that rotates said tool in a mixing direction, the vessel containing at least the following three types of openings:

a feed opening of the solid ingredient space;

a feed opening of the liquid space;

an evacuation opening of the mixed dough, said opening being provided in the lateral part of the periphery of the mixing space.

Thus, by providing centrifugal mixing of the dough, which is combined with lateral evacuation, the device permits the tool to simultaneously ensure optimal mixing and evacuation of the mixed dough.

According to a second aspect, the invention concerns a process for production of a dough based on water and flour, said process providing for continuous mixing of the ingredients of said dough with a mixing device according to the first aspect, and then kneading of said dough, which is evacuated from the device.

According to a third aspect, the invention concerns an installation for using this process, comprising a mixing device according to the first aspect, and a kneading vessel, in which kneading tools are arranged, said vessel containing an upstream feed opening of the mixture being kneaded, which is connected to or arranged opposite the evacuation opening, and a downstream outlet opening of the kneaded dough, said vessel being arranged to permit displacement of the dough in the vessel from the upstream opening to the downstream opening during continuous feed of the vessel with the mixture evacuated from the mixing device.

### BRIEF DESCRIPTION OF THE DRAWINGS

Other objects and advantages of the invention will be apparent from the following description with reference to the appended drawings, in which:

FIG. 1 is a plane view of a mixing device according to a first variant, said device containing a vessel, shown in partial cross section, within which a tool is mounted to rotate, said vessel containing a central feed opening for solid ingredients, three upper feed openings for liquid and a lateral evacuation opening for the mixed dough, evacuation being tangential;

FIG. 2 is a partial cross sectional view of the device of FIG. 1, showing the vessel of the device, said vessel defining a mixing space in which the mixing tool is mounted to rotate;

FIG. 3 is a partial top view of the device of FIG. 1, in which the liquid feed opening, evacuation opening are shown and, because of transparence of the upper wall of the vessel, the tool in the mixing space and its direction of rotation, the feed openings being arranged in front of the evacuation opening relative to the direction of rotation of the mixing tool;

FIG. 4 is a partial cross sectional view of the device of FIG. 1, showing the tangential arrangement of the evacuation opening;

FIGS. 5 and 6 are figures similar to FIGS. 3 and 4, showing a mixing device according to a second variant, in which evacuation of the mixed dough is radial;

FIG. 7 shows representations of the mixing tool according to a variant, in which the tool contains three equally distributed blades;

FIG. 8 is a schematic view of a continuous production installation for dough based on water and flour, containing a mixing device according to FIG. 1.

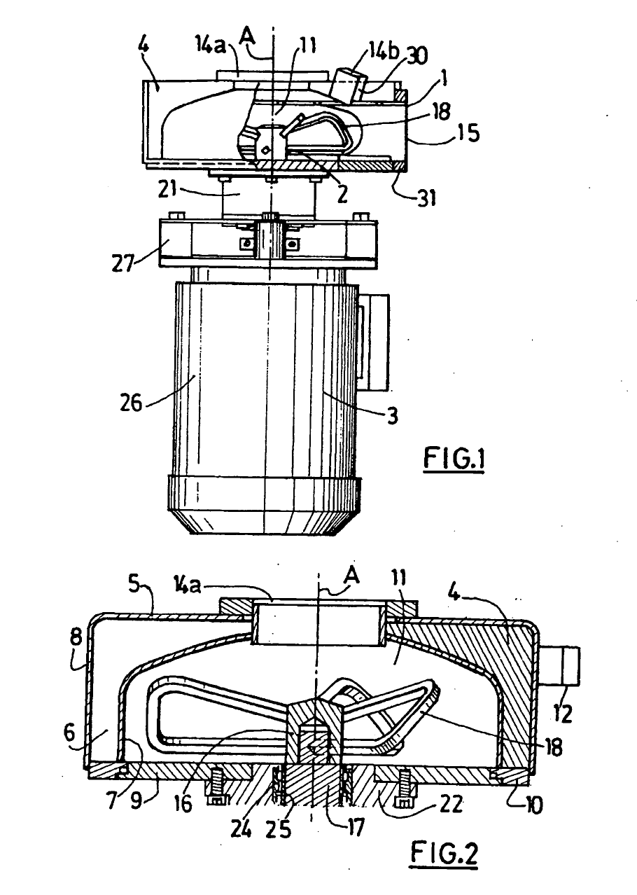

### DETAILED DESCRIPTION

In the figures, a continuous mixing device for ingredients of a dough based on water and flour is shown.

The term dough based on water and flour can denote any mixture containing water and flour in proportions adapted to the desired type of dough. This can be more or less fluid, more or less viscous. In particular, the term dough can denote liquid leaven.

The device, in particular, permits grinding of the dough prior to its kneading. However, considering the quality of mixing obtained with the device according to the invention, the mixed dough, in some applications, can be used without later kneading.

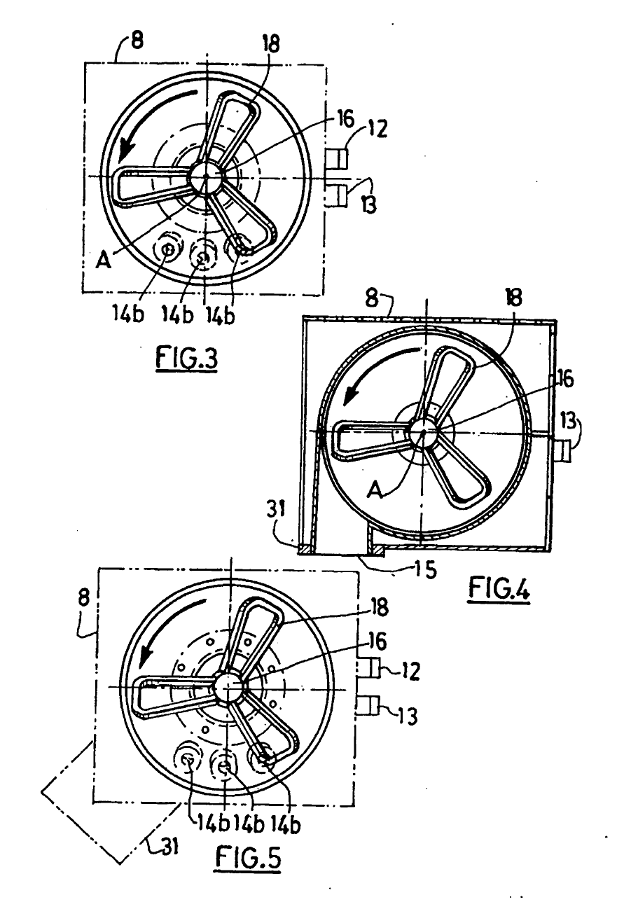

The device contains a mixing vessel 1, within which a mixing tool 2 is mounted to rotate round an axis A. The device also includes motorized device 3 to rotate tool 2 in a mixing direction, shown in FIGS. 3 to 6 with an arrow pointing counterclockwise.

In the following description, the terms “axial” or “longitudinal” and “radial” or “transverse” refer to planes parallel and perpendicular to axis 8, respectively.

The mixing vessel 1 has a general cylindrical shape and is arranged coaxial to axis A. Vessel 1 contains a bell 4 formed from an upper wall 5, whose outside surface is essentially flat, and whose inside surface is essentially spherical, and a lateral skirt 6 extending vertically from the periphery of upper wall 5. Skirt 6 contains an essentially cylindrical internal edge 7 with a circular cross section and an essentially cylindrical external edge 8 with a polygonal cross section, especially square in the figure, or circular. On the opposite side of upper wall 5, the skirt is sealed to a generally flat support 9. For example, an annular part 10 arranged around support 9 permits support 9 and bell 4 to be connected, on the one hand, and ensures sealing of vessel 1, on the other. One can also provide additional sealing joints between annular part 10 and support 9 and/or between bell 4 and annular part 10.

The inside surface of upper wall 5, the cylindrical edge 7 and the upper, essentially flat surface of the support 9 define a mixing space 11, in which the mixing tool 2 is arranged, having a circular cross section of radius R. In a particular example, the value of radius R can be between 20 cm and 70 cm.

Vessel 1 can include devices used in the preparation of a dough based on water and flour. Such devices, for example, permit the conditions, under which the ingredients are mixed, to be controlled. This can involve a cooling device. Vessel 1 then contains a chamber for circulation of cooling fluid, like glycol, between an upstream port 12 and a downstream port 13, provided on the outside edge 8 of skirt 6. In the depicted variant, the upstream port 12 and downstream port 13 are situated next to each other on both sides of the longitudinal median plane and the transverse median plane and are longitudinally and transversely offset relative to each other.

In a complementary variant, variant 1 can include a heating device and contain several circulation chambers between the upstream and downstream ports.

The ingredients introduced to the mixing space 11 are mixed by a mixing tool 2 between the feed opening 14 for the ingredients and the opening 15 provided in the lateral part of the periphery of mixing space 11, for example, made in the cylindrical edge 7 and traversing skirt 6, permitting evacuation of the mixed dough.

To do this, the mixing tool 2 arranged in vessel 1 contains a hub 16 for connection to a motor shaft 17 and one or more arms 18 that extend radially from hub 16. Each arm 18 is inclined relative to the mixing direction forward, so as to present an attack surface of the dough, whose normal is oriented toward the bottom of the mixing space 11.

Choice of the number of arms 18, their shape and inclination of the surface of attack permits the device to be adapted to the desired type of mixed dough.

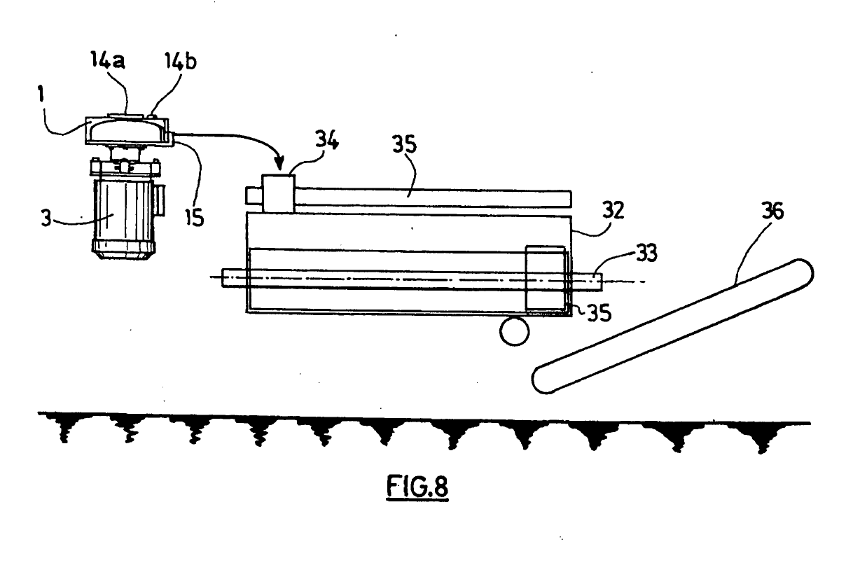

In particular, according to one variant, the tool 2 contains three identical arms, distributed equally around hub 16, with an angular distance equal to 120° (FIG. 8a). This device offers the advantage of better stability during rotation of tool 2.

Each arm 18 contains a U-shaped tube with a polygonal cross section, especially square or triangular or circular (FIG. 8c). The base 19 of the U faces the internal lateral edge 7, so that the branches 20 are arranged one above the other and form the attack surface of the dough. The two arms 20 of the U are connected to hub 16, so that the upper arm 20 is arranged relative to the mixing direction in front of the lower arm 20 (FIG. 8b). For example, the angle between the normal of the attack surface and the axis of rotation A is about 45°.

Moreover, the length of each arm 18 is between 70% and 90% of the value of radius R of the mixing space 11. Tool 2 is arranged facing and at a distance from the upper surface of support 9, so that the distance between the lower end of arm 18 and support 9 is less than the distance between the radial end of arm 18 and the inside cylindrical edge 7.

Thus, in this particular variant, during rotation of tool 2, work of the dough combines shear, rolling on the inside edge 7, coating on the upper surface of support 9 and centrifuging.

To ensure rotation of mixing tool 2, the motorized device 3 can contain one or more motors that rotate the motor shaft 17, to which mixing tool 2 is connected. It can also be prescribed that the motorized device 3 has regulators that permit adjustment of the rotational speed, for example, to the type of mixture or to the desired output. In a particular example, the motorized device 3 drives tool 2 at a rotational speed of about 750 rpm. The time, during which the dough is mixed in a closed circuit by tool 2, is then about 20 seconds.

The work of the dough obtained by tool 2 according to the invention at this rotational speed permits an improvement in the mixing quality and achieves a first kneading of the mixed dough before its introduction to an kneading vessel.

Moreover, tool 2 is mounted to rotate relative to vessel 1 by means of a guide and sealing device 21 attached to the support (FIG. 3). This device 21 is described, for example, in document FR-A 2 814 514 from the applicant. It contains a body 22, rollers interposed between body 22 and motor shaft 17 and means of sealing 24, like joints. This type of device is integrated on the motor shaft 17 to move by means of a liner 25, so as to permit repair or rapid replacement of parts forming device 21, without disassembling the motor shaft 17.

The guide and sealing device 21 is mounted between support 9 of vessel 1 and a housing 26 that encloses the motorized device 3 by means of four vertical joints 27.

Upstream of the mixing device, prior to introduction to the mixing space 11, the ingredients being mixed to obtain the desired type of dough are metered in the required amounts. These ingredients include flour, water and other elements used in baking, for example, oil, leaven or enhancers, like ascorbic acid.

Continuous travel to the mixing device of the ingredients is accomplished by continuous means of transport and feed, not shown in the figures. The means of transport can be present in the form of conduits with an essentially circular cross section or essentially rectangular cross section made of a flexible or rigid material or a combination of both.

The transport means are connected to the feed openings 14 for the ingredients, provided on the upper wall 5 of vessel 1 to permit continuous introduction to mixing space 11 of the ingredients of the dough. According to the invention, the openings 14 are different, depending on the nature of the ingredient. One thus distinguishes:

the feed opening or openings 14a of the space 11 for solid ingredients;

the feed opening or openings 14b of the liquid space 11.

The device in the figures contains a feed opening for solid ingredients 14a, arranged essentially coaxial to rotational axis A of the mixing tool 2. Thus, the solid ingredients are introduced axially into mixing space 11 at the level of the hub of tool 16. The feed opening for solid ingredients 14a can be used to introduce to the mixing device other types of solid ingredients not directly involved in the composition of the dough proper. These ingredients can be of different nature and form. For example, these ingredients can be chocolate (chips or molten), dried fruits, etc.

Moreover, the device also contains three liquid feed openings 14b. These openings 14b, connected to the transport device, permit introduction of a liquid, especially water, into the vessel.

The liquid feed openings 14b are arranged relative to the mixing direction in front of the evacuation opening 14. Thus, with this arrangement, the dough essentially makes a complete revolution in the mixing space 11 between the moment when the ingredients enter into contact with each other and the moment when the mixed dough is evacuated from space 11. The distance and duration of mixing are maximal, so as to improve the quality of the obtained mixed dough.

Moreover, the liquid feed openings 14b are radially eccentric relative to axis A. For example, they are provided at a distance from axis A between 40% and 70% of radius R of the mixing space 11. In the figures, the liquid feed openings 14b are situated on an arc of a circle, whose radius is greater than half the radius R of space 11 and are arranged near each other, so as to be essentially aligned. This arrangement of openings 14, on the one hand, permits the risk of clogging and blocking of the feed opening for solid ingredients 14a to be avoided, if supply of liquid is accomplished near axis A, and, on the other hand, permits homogenization of the mixture and limits the amount of unmixed fluid with the solid ingredients, if liquid feed is accomplished near the internal edge 7 of skirt 6.

In the considered example, it is prescribed that the feed opening for liquid 14b closest to evacuation opening 14 permits introduction of liquid leaven, the feed opening 14b farthest from evacuation opening 15 permits introduction of oil and the central feed opening 14b permits introduction of water.

To ensure a satisfactory and homogeneous wetting of all the solid ingredients in the mixing space, at least the water feed opening 14b is provided with a nozzle 30 arranged to permit introduction of liquid, for example, in an essentially solid cone or curtain. The liquids are injected in fine droplets at low pressure, so as to form a mist that permits essentially instantaneous wetting of the solid ingredients.

Evacuation of the mixed dough is accomplished through evacuation opening 15 provided with a conduit 31. Output of the mixed dough is accomplished, on the one hand, by the centrifugal effect due to rotation of tool 2 within vessel 1, and, on the other hand, by shear against the edge of conduit 31 situated in front relative to the direction of rotation of tool 2.

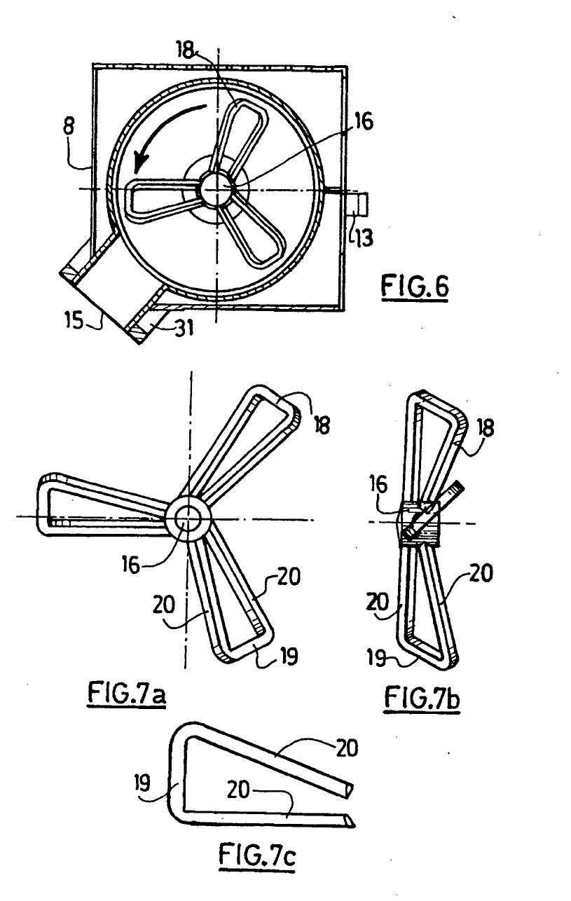

Conduit 31 can be arranged to form an angle between 0° and 90° relative to a radius of the mixing space 11. In FIGS. 4 and 5, on the one hand, and FIGS. 6 and 7, on the other, two variants for evaluation of the mixed dough are shown. According to the first variant, shown in FIGS. 4 and 5, the angle is equal to essentially 90°, so as to ensure tangential evacuation of the mixed dough. According to a second variant, shown in FIGS. 6 and 7, the angle is equal to essentially 0°, so as to ensure radial evacuation of the mixed dough.

In order to facilitate maintenance and cleaning of vessel 1 or to control feed of ingredients and evacuation of mixed dough, it can be prescribed that the different openings 14, 15 are provided with an isolation valve (not shown), especially a valve with a sleeve.

The mixing device just described can be used in an installation for batchwise or continuous production of a dough based on flour and water.

For an installation, in which the dough based on flour and water is made batchwise, a process is used, in which the ingredients of the dough are continuously mixed in the mixing device, the mixed dough evacuated from the device is then recovered before being kneaded in a kneading vessel.

For an installation, in which the dough based on flour and water is produced continuously, a process is used, in which the ingredients of the dough are continuously mixed in the mixing device, the evacuated mixed dough from the device is continuously kneaded in a kneading vessel.

To do this, this last installation, a shown in FIG. 9, contains the mixing device and a kneading vessel 32, in which kneading tools 33 are arranged near the bottom of the vessel. The mixing device and kneading vessel 32 are mounted on a chassis (not shown).

Vessel 32 contains a first and second essentially vertical lateral connected by the bottom of the vessel. The opening of vessel 32 can be covered with a cover 35 mounted to move on vessel 32. Vessel 32 contains on its upper part an upstream opening 34 to supply the mixed dough to be kneaded. The upstream opening 34 is connected to the evacuation opening 15 of the mixing device, for example, by means of two transport devices that can be present in the form of conduits with an essentially circular or rectangular cross section made of flexible or rigid material or a combination of both. It can also be prescribed that the upstream opening 34 of vessel 32 be arranged facing the evacuation opening 15.

Vessel 32 is arranged, during continuous feed of vessel 32 with mixed dough from the mixing device, to permit displacement of the mixed dough in vessel 32 from upstream opening 34 and a downstream opening 35 for output of the kneaded dough. The downstream opening 35 is situated on a lateral face of vessel 32 and positioned at a predetermined distance from a recovery device 36, like an endless belt, for the kneaded dough leaving vessel 32.

1. A continuous mixing device for ingredients of a dough based on flour and water, said device comprising: a vessel that defines a mixing space having a circular cross section of radius R, in which a mixing tool, containing at least one radial arm is mounted to rotate around an axis A, and a motorized device that rotates said tool in a mixing direction, wherein the vessel contains at least the following three types of openings:
a feed opening for solid ingredients of space;
a feed opening for liquid of space; and
an evacuation opening for the mixed dough, said opening being provided in a lateral part of a periphery of the mixing space.

2. The continuous mixing device according to claim 1, wherein the feed openings are provided on an upper wall of the vessel, the feed opening for solid ingredients being essentially coaxial to axis A of rotation of the tool, and the liquid feed opening being radially eccentric relative to said axis.

3. The continuous mixing device according to claim 2, wherein the liquid feed opening is provided at a distance from axis of rotation A between 40% and 60% of radius R of the mixing space.

4. The continuous mixing device according to claim 3, wherein the liquid feed opening is arranged relative to the mixing direction, upstream of the evacuation opening.

5. The continuous mixing device according to claim 4, wherein the liquid feed opening is provided with a nozzle arranged to permit introduction of liquid into the mixing space according to an essentially solid cone.

6. The continuous mixing device according to claim 5, wherein the evacuation opening is provided with a conduit arranged to form an angle between 0° and 90° relative to a radius of the mixing space.

7. The continuous mixing device according to claim 6, wherein the angle is equal to essentially 0°, so as to ensure radial evacuation of the mixed dough.

8. The continuous mixing device according to claim 6, wherein the angle is equal to essentially 90°, so as to ensure tangential evacuation of the mixed dough.

9. The continuous mixing device according to claim 8, wherein the vessel contains a bell with a lateral internal edge essentially cylindrical, which is tightly connected on support, the evacuation opening being made in cylindrical edge.

10. The continuous mixing device according to claim 9, wherein the support has an upper surface that is essentially flat, facing and at a distance from which tool is arranged.

11. The continuous mixing device according to claim 9, wherein the distance between the upper end of arm and support is less than the distance between the radial end of arm and cylindrical edge.

12. The continuous mixing device according to claim 11, wherein the length of arm of tool is between 70% and 90% of the radius of the mixing space.

13. The continuous mixing device according to claim 12, wherein the arm is inclined relative to the mixing direction forward, so as to present an attack surface of the dough, whose normal is oriented toward the bottom of the mixing space.

14. The continuous mixing device according to claim 13, wherein the angle between the normal of the attack surface and axis A of rotation is about 45°.

15. The continuous mixing device according to claim 14, wherein the tool contains a hub for connection to a motor, three identical arms (18) extending radially from said hub, the arms being distributed equally around hub with an angular distance equal to 120°.

16. The continuous mixing device according to claim 15 wherein each arm contains a U-shaped tube, the two arms of the U being connected to the hub, so that the upper arm of the U is arranged relative to the mixing direction in front of the lower arm of the U, the attack surface of the dough being formed between said arms.

17. The continuous mixing device according to claim 16, wherein the vessel contains at least one fluid circulation chamber between an upstream port and a downstream port, said ports being provided on the outside wall of said vessel.

18. The continuous mixing device according to claim 17, wherein at least one opening is provided with a valve.

19. A process for production of a dough based on flour and water, said process providing for continuous mixing of the ingredients of said dough by means of a mixing device according to claim 1, and then kneading of said dough, which is evacuated from the device.

20. A process for production according to claim 19, wherein the dough evacuated from the mixing device is recovered before kneading.

21. A process for production according to claim 19, wherein the dough evacuated from the mixing device is continuously kneaded.

22. An installation for employment of the process according to claim 21, containing a mixing device according to claim 1, and a kneading vessel, in which kneading tools are arranged, said vessel containing an upstream opening to supply the mixture to be kneaded, which is connected to or arranged facing the evacuation opening, and a downstream opening for output of the kneaded dough, said vessel being arranged to permit displacement of the dough in vessel from the upstream opening to the downstream opening during continuous feed of vessel with the mixture evacuated from the mixing device.

23. An installation according to claim 22, wherein the feed opening is provided on the upper part of vessel, the output opening being arranged on a lateral face of said vessel.
